(19) United States
(12) Patent Application Publication
(10) Pub. No.: US 2014/0250665 A1
(43) Pub. Date: Sep. 11, 2014

(54) Z-PIN PATCH AND METHOD FOR MANUFACTURING OR COUPLING A COMPOSITE LAMINATED STRUCTURE USING SAME

(71) Applicant: Korea Aerospace Research Institute, Daejeon (KR)

(72) Inventors: Ik Hyeon Choi, Daejeon (KR); Cheol Ho Lim, Daejeon (KR); Eun Sup Sim, Nonsan-si (KR)

(21) Appl. No.: 14/349,756

(22) PCT Filed: Sep. 25, 2012
(86) PCT No.: PCT/KR2012/007722

§ 371 Date: Apr. 7, 2014

(30) Foreign Application Priority Data
Oct. 7, 2011 (KR) 10-2011-0102189
Sep. 25, 2012 (KR) 10-2012-0106463

(51) Int. Cl. B32B 3/06; B32B 7/08

(52) U.S. Cl. CPC B32B 3/06; B32B 7/08
USPC 29/432; 428/195.1

(57) ABSTRACT

Provided are a Z-pinning patch capable of improving process efficiency, productivity, and the like, by allowing Z-pinning of a composite laminated structure to be realized using a structure as simple as possible, and a method for manufacturing or jointing composite laminated structures using the same. The Z-pinning patch used for Z-pinning for reinforcing delamination performance of composite laminated structures or connecting between a plurality of laminated members, includes: a base plate formed in a plate form; and a plurality of pins fixed to one side of the base plate.

### TECHNICAL FIELD

The present invention relates to a Z-pinning patch capable of reinforcing interlayer performance of composite laminated structures or connecting between a plurality of laminated members by inserting pins into the composite laminated structure in a thickness direction of the composite laminated structure, and a method for manufacturing or jointing composite laminated structures using the same.

A fiber reinforced composite mainly used in a lightweight structure such as an aerospace and transport mechanism structure member, or the like, is mainly prepared by laminating woven prepregs in one direction and performing a molding process of applying heat and pressure to the prepregs. Since the composite laminated structures laminated and cured (molded) as described above do not include a separate reinforcing material in a thickness direction, an delamination (interlayer separation) phenomenon that layers are separated from each other is easily generated due to external impact, or the like. Since the delamination decreases strength of the structure, many researches into a method for preventing the delamination have been conducted by researchers of the related field. That is, in order to reinforce a vulnerable delamination feature of the composite laminated structures, many researches into a method such as stitching, Z-pinning, textile, toughened matrix, or the like, have been conducted.

Among researches for improving interlayer performance of composite laminated structures or connecting between two composite laminated structures, a research into a Z-pinning technology has relatively recently started. Well-known technologies for the Z-pinning will be schematically described below.

An initial concept of a Z-pinning method has disclosed in U.S. Pat. No. 4,808,461 (Feb. 28, 1989) (hereinafter, referred to as the prior art 1). A core concept of the prior art 1 is as follows. At the time of molding a ‘reinforced structure’ including pins inserted into a polyvinyl based form in a thickness direction, a thin stainless plate attached to an upper portion thereof, and a release agent film attached to a lower portion, the reinforced structure is positioned and cured on a composite on which it is to be laminated, such that the pins are inserted into a laminated plate while a preform collapses by a high temperature and a high pressure in a process of molding the reinforced structure (See FIG. 1). When the molding is completed, a residual of the preform compressed due to the collapse is removed and the pins protruding by a thickness of the preform are broken and removed by physical power. In this case, since the pins remain in a laminated structure in the thickness direction, delamination performance is improved. The prior art 1 is characterized by the method and the ‘reinforced structure’ as described above. However, it has not been reported up to now that this concept successfully put to practical use.

Then, U.S. Pat. No. 5,186,776 (Feb. 16, 1993) (hereinafter, referred to as the prior art 2) has disclosed a mechanical apparatus capable of performing a series of operations of directly molding pins from a bundle of composite reinforced fibers and applying ultrasonic vibrations to the cured pins to insert the pins into a composite laminated structure, and a method thereof, and U.S. Pat. No. 5,589,015 (Dec. 31, 1996) (hereinafter, referred to as the prior art 3) has disclosed a method and a system of compressing a compressible ‘form structure’ into which pins are inserted in advance while applying vibrations to the compressible form structure using an ultrasonic vibrating apparatus to insert the pins into a composite laminated structure before being cured or after being cured. It has been known that the prior art 3 has been put to practical use and has been used in a duct structure connecting part of a rear fuselage of F/A-18 E/F. Then, in connection with Z-pinning, U.S. Pat. No. 5,667,859 (1997), U.S. Pat. No. 5,800,672 (1998), U.S. Pat. No. 5,919,413 (1999), U.S. Pat. No. 6,190,602 (2001), U.S. Pat. No. 6,291,049 (2001), U.S. Pat. No. 6,405,417 (2002), U.S. Pat. No. 6,436,507 (2002), and the like, have been disclosed. However, in these Patents, a ‘reinforced structure’ and a ‘form structure’, which are initial concepts, have been continuously used.

### BACKGROUND ART

FIG. 1 is a diagram showing a general composite molding method. A release agent 112 is applied onto a mold 111 for molding a composite, a composite prepreg laminate 121 is disposed thereon, the release agent 112 and a bleeder 113 absorbing a resin are applied, an entire composite is covered by a film bag 115 to which an adaptor 116 providing vacuum is attached, and an edge of the composite is sealed by a sealant 117. A cork dam 114 may not also be used depending on a feature of a molding method for molding the composite laminated structure 121.

FIG. 2 is a diagram of a Z-pinning method according to the prior art and shows a concept of the prior art 1. When molding is performed in a state in which a ‘reinforced structure 230’ including pins 231 inserted into a compressible form 232, a stainless plate attached to an upper portion thereof, and a release agent film attached to a lower portion is disposed as shown in FIG. 2, the pins 231 are inserted into a composite laminated structure 221 while the compressible form 232 collapses by a molding pressure and a molding temperature.

FIG. 3 is another diagram of a Z-pinning method according to the prior art and shows the case of molding a composite laminated structure having a non-uniform thickness by the Z-pinning method according to the prior art. In the case of molding the composite laminated structure having the non-uniform thickness by the Z-pinning method according to the prior art, a stainless plate attached to an upper portion of a ‘reinforced structure 330’ hinders deformation, which is troublesome. Even though a ‘form structure’ to which the stainless plate is not attached is used, in the case in which a ‘form structure 330 (similar to the reinforced structure 230)’ including pins 331 having a uniform length is used, it is difficult to satisfy a molding condition at both of a portion 322 at which a thickness of the composite is thick and a portion 323 at which it is thin. That is, when the lengths of the pins 331 are adjusted to be matched to the thick portion 322, the lengths of the pins 331 are long at the thin portion 323, such that a molding pressure does not act on the composite laminated structure 323. As a result, a basic requirement in molding the composite (a requirement that a high pressure of about 7 to 8 atmospheres or 20 atmospheres depending on a material needs to act on the composite laminated structure in order to remove air bubbles generated in the composite laminated structure in a molding step and discharge extra resins) is not satisfied. Further, when the lengths of the pins 331 are adjusted to be matched to the thin portion 323, the lengths of the pins 331 are short at the thick portion 322, such that the pins are inserted into only a portion of the laminated structure in a thickness direction. As a result, an effect of the Z-pinning method is not sufficiently exhibited. Therefore, in order to mold the composite laminated structure having a non-uniform thickness by the Z-pinning method according to the prior art, the thickness of the ‘form structure 330’ should be changed so as to be matched to the laminated structure. This process may not be easy due to characteristics of a structure of a compressible form 332.

As described above, the prior arts have commonly used the ‘form structure’ (the ‘reinforced structure may also be considered as a kind of ‘form structure’) having a feature that the pins are inserted into the form in advance in order to be inserted into the composite laminated structure and are inserted into the composite laminated structure while the form is compressed and collapses by an external vibration load or a molding pressure as a medium and have the ‘form structure’ as their technical features. However, in the case of using the ‘form structure’ according to the prior art, the form that is compressed and collapses should be artificially removed after the pins are inserted, the protruding parts of the pins should be forcibly broken and removed. Therefore, wasteful spending of a material and inefficiency of a process are inevitable. In addition, partial scratches may occur at positions at which the pins are broken and removed, and strength of the pins and structures around the pins is negatively affected in a process of breaking the pins.

Furthermore, in the method for inserting the pins into the composite laminated structure using the form structure or the reinforced structure as described above, in the case in which a height of the composite laminated structure is not uniform, a depth at which the pins are inserted is changed depending on the height. Therefore, the composite laminated structure manufactured according to the prior art and having the non-uniform has a large problem that interlayer rigidity is not uniform. Alternatively, in the method for performing Z-pinning on the composite laminated structure having a non-uniform height according to the prior art, a configuration of an apparatus is complicated, and a process is difficult, such that it is difficult to apply the method for performing Z-pinning on the composite laminated structure having a non-uniform height according to the prior art.

FIG. 4 is a diagram of Korean Patent No. 0932302 (Dec. 8, 2009) (hereinafter, referred to as a prior art 4) entitled “Composite Laminated Structure Having Performance Reinforced by Inserting Pins, Method and Apparatus of Manufacturing Composite Laminated Structure, and Method for Manufacturing Apparatus” filled by the present applicant. In the prior art 4, referring to FIG. 4, an apparatus of manufacturing a composite laminated structure configured to include a lower guide 450 disposed on a composite laminated structure 421 in a state before being cured or after being cured and including pins 451 that are each disposed in a plurality of holes formed in a vertical direction and are to be inserted into the composite laminated structure 421; and an upper guide 440 disposed on the lower guide 450 and including guide pins 441 formed at positions corresponding to those of the pins 451 so as to be movable in the vertical direction and moving the upper guide toward the lower guide, such that the guide pins press the pins to insert the pins into the composite laminated structure has been disclosed. In the prior art 4, which improves a process by further simplifying a structure without using the complicated form structure used in the above-mentioned prior arts 1 to 3, Z-pinning may be performed by a significantly simple structure, and repeated use is possible, such that process efficiency is further improved. However, since the prior art 4 is also configured to use upper and lower jigs, there is a need to further decrease the number of components used in a process and simplify the process.

### PRIOR ART DOCUMENT

### Patent Document

1. U.S. Pat. No. 4,808,461 (Feb. 28, 1989)

2. U.S. Pat. No. 5,186,776 (Feb. 2, 1993)

3. U.S. Pat. No. 5,589,015 (Dec. 31, 1996)

4. U.S. Pat. No. 5,667,859 (1997)

5. U.S. Pat. No. 5,800,672 (1998)

6. U.S. Pat. No. 5,919,413 (1999)

7. U.S. Pat. No. 6,190,602 (2001)

8. U.S. Pat. No. 6,291,049 (2001)

9. U.S. Pat. No. 6,405,417 (2002)

10. U.S. Pat. No. 6,436,507 (2002)

11. Korean Patent No. 0932302 (Dec. 8, 2009)

### DISCLOSURE

### Technical Problem

An object of the present invention is to provide a Z-pinning patch capable of improving process efficiency, productivity, and the like, by allowing Z-pinning of a composite laminated structure to be realized using a structure as simple as possible, and a method for manufacturing or jointing composite laminated structures using the same.

### Technical Solution

In one general aspect, a Z-pinning patch 30 used for Z-pinning for reinforcing delamination performance of composite laminated structures 21 or connecting between a plurality of laminated members, includes: a base plate 31 formed in a plate form; and a plurality of pins 32 fixed to one side of the base plate 31.

The pin 32 side may be disposed on the composite laminated structure 21 before being cured or after being cured, and the pins 32 may be inserted into the composite laminated structure 21 in a process of molding or jointing the composite laminated structures 21 to thereby be Z-pinned.

The pins 32 may be formed in a form in which they protrude in a vertical direction or in a direction inclined with respect to the base plate 31.

Angles at which the plurality of pins 32 protrude with respect to the base plate 31 may be the same as each other.

The Z-pinning patch 30 may be guided by a patch guide 40 including a lower guide 42 having an opening part formed therein so that the Z-pinning patch 30 passes therethrough and an upper guide 41 disposed at one side of the opening part of the lower guide 42 so as to be inserted and moved into the opening part, such that it is inserted into the composite laminated structure 21.

The pin 32 may have a lower end portion 32a formed in a sharp form. The pin 32 may have an unevenness 32b formed on a surface thereof. When the surface of the pin is chemically etched, adhesion characteristics may be further improved.

In another general aspect, a method for manufacturing a composite laminated structure using the Z-pinning patch as described above, includes: a1) disposing the composite laminated structure 21 before being cured or after being cured; a2) disposing the Z-pinning patch 30 on the composite laminated structure 21 before being cured or after being cured so that the other side of the pin 32 contacts the composite laminated structure 21; and a3) applying pressing force to the base plate 31 to insert the pins 32 into the composite laminated structure 21.

In still another general aspect, a method for manufacturing a composite laminated structure using the Z-pinning patch as described above, includes: b1) disposing the composite laminated structure 21 before being cured or after being cured; b2) disposing the Z-pinning patch 30 on the composite laminated structure 21 before being cured or after being cured so that the other side of the pin 32 contacts the composite laminated structure 21; b3) covering the Z-pinning patch 30 with the patch guide 40 so that the Z-pinning patch 30 is inserted into the opening part of the lower guide 42; and b4) applying pressing force to the upper guide 41 to insert the pins 32 into the composite laminated structure 21.

In yet still another general aspect, a method for jointing composite laminated structures to each other using the Z-pinning patch as described above, includes: c1) sequentially disposing a lower composite laminated structure member 21b and an upper composite laminated structure member 21t from the bottom; c2) disposing the Z-pinning patch 30 on the upper composite laminated structure member 21t so that the other side of the pin 32 contacts the upper composite laminated structure member 21t; and c3) applying pressing force to the base plate 31 to insert the pins 32 into the laminated composite laminated structure members 21b and 21t.

In yet still another general aspect, a method for jointing composite laminated structures to each other using the Z-pinning patch as described above, includes: d1) sequentially disposing a lower composite laminated structure member 21b and an upper composite laminated structure member 21t from the bottom; d2) disposing the Z-pinning patch 30 on the upper composite laminated structure member 21t so that the other side of the pin 32 contacts the upper composite laminated structure member 21t; and d3) covering the Z-pinning patch 30 with the patch guide 40 so that the Z-pinning patch 30 is inserted into the opening part of the lower guide 42; d4) applying pressing force to the upper guide 41 to insert the pins 32 into the laminated composite laminated structure members 21b and 21t.

The composite laminated structure members 21b and 21t may be a state in which they are coupled to each other through a primary jointing process including an adhering process, a compressing process, or a heat-attaching process.

### Advantageous Effects

According to an exemplary embodiment, in manufacturing a composite laminated structure having vulnerable delamination performance, a Z-pinning method in which pins are inserted into the composite laminated structure in a thickness direction of the composite laminated structure is basically used, thereby making it possible to reinforce the delamination performance and connect two composite laminated structures to each other.

In addition, the present invention may be applied to a composite laminated structure having a non-uniform thickness and may allow high quality pinning to be performed in the composite laminated structure having a non-uniform thickness.

Further, according to an exemplary embodiment of the present invention, even in the case in which a pin may be separated due to an external load applied to the composite laminated structure, the pin having a surface processed in an unevenness form is inserted into the composite laminated structure so that it is not easily separated, thereby making it possible to further improve jointing force. Furthermore, when the surface of the pin is chemically etched, adhesion characteristics may be further improved.

First of all, according to an exemplary embodiment of the present invention, a problem that a material is inevitably wastefully spent due to the use of a one-time ‘form structure’ (including a ‘reinforced structure’) in the Z-pinning method according to the prior art and it is difficult to apply the Z-pinning method according to the prior art to a composite laminated structure having a non-uniform thickness may be completely solved. That is, in an exemplary embodiment of the present invention, the Z-pinning is performed using a patch having a form in which a plurality of pins are vertically formed on a thin plate, and this patch is manufactured in advance and is then supplied, such that a process of actually manufacturing a composite laminated structure itself is may be significantly simplified. In more detail, components such as a form structure, a reinforced structure, various jigs, and the like, according to the prior art are not required, such that the number of components and the number of processes may be significantly decreased. Therefore, a manufacturing cost is decreased and production efficiency is improved, as compared with the prior art, such that an excellent economical effect may be accomplished.

### DESCRIPTION OF DRAWINGS

FIG. 1 is a diagram of a general composite molding method;

FIG. 2 is a diagram of a Z-pinning method according to the prior art;

FIG. 3 is another diagram of a Z-pinning method according to the prior art;

FIG. 4 is still another diagram of a Z-pinning method according to the prior art;

FIGS. 5 and 6 are diagrams showing a Z-pinning patch according to an exemplary embodiment of the present invention;

FIGS. 7 and 8 are diagrams showing a method for manufacturing a composite laminated structure using a Z-pinning patch according to an exemplary embodiment of the present invention;

FIGS. 9 and 10 are diagrams showing a method for manufacturing a composite laminated structure using a Z-pinning patch according to another exemplary embodiment of the present invention;

FIG. 11 is a diagram showing a method for manufacturing a composite laminated structure using a Z-pinning patch according to still another exemplary embodiment of the present invention;

FIG. 12 is a diagram showing a Z-pinning patch according to another exemplary embodiment of the present invention;

FIGS. 13 and 14 are diagrams showing composite laminated structures coupled to each other by a method for jointing a composite laminated structure using the Z-pinning patch according to an exemplary embodiment of the present invention; and

FIG. 15 is a diagram showing a form of a pin according to an exemplary embodiment of the present invention.

[Detailed Description of Main Elements]

| | |
|---|---|
| 11: Mold | 12: (Release agent) film |
| 13: Bleeder | 14: Cork dam |
| 15: Flim Bag | 16: Adapter |
| 17: Sealant | |
| 21: Composite laminated | |
| structure | |
| 21t: Upper composite laminated | |
| structure member | |
| 21b: Lower composite laminated | |
| structure member | |
| 30: Z-pinning patch (according | |
| to an exemplary embodiment of | |
| the present invention) | |
| 31: Base plate | 32: Pin |
| 32a: Lower end portion | 32b: Unevenness |
| 40: Patch guide | |
| 41: Upper guide | 42: Lower guide |

### BEST MODE

Hereinafter, a Z-pinning patch according to an exemplary embodiment of the present invention having the configuration as described above and a method for manufacturing or jointing composite laminated structures using the same will be described in detail with reference to the accompanying drawings.

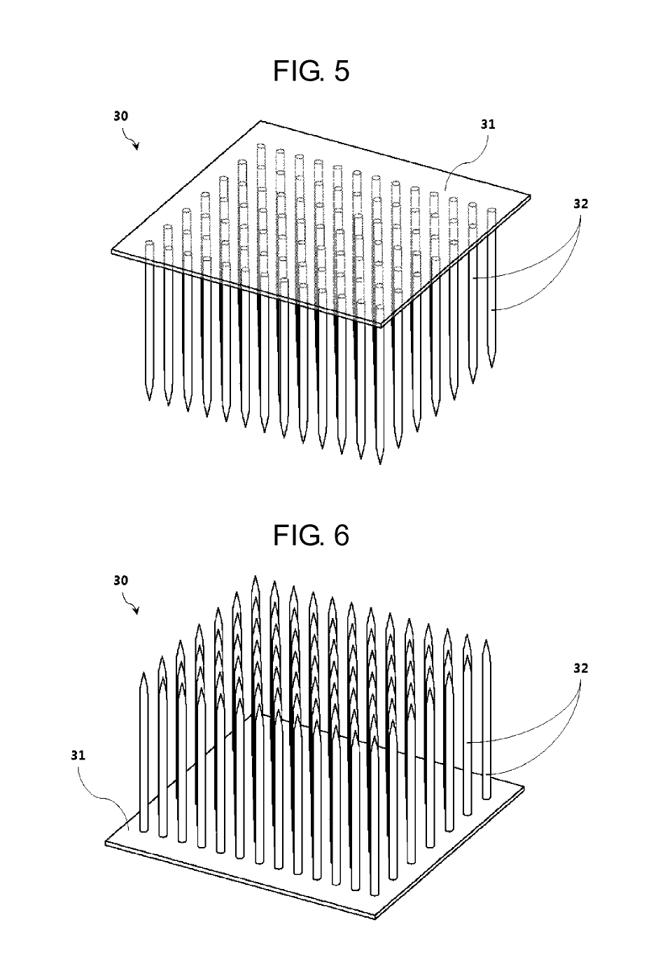

FIGS. 5 and 6 are diagrams showing a typical form of a Z-pinning patch according to an exemplary embodiment of the present invention. The Z-pinning patch according to an exemplary embodiment of the present invention, which is used for Z-pinning for reinforcing interlay separation performance of a composite laminated structure 21 or connecting between a plurality of laminated members, has a very simple structure as shown in FIGS. 5 and 6. That is, the Z-pinning patch 30 according to an exemplary embodiment of the present invention has a very simple structure in which it is configured to include a base plate 31 formed in a plate form and a plurality of pins 32 fixed to one side of the base plate 31. In the Z-pinning patch 30 formed as described above, the pin 32 side is disposed on the composite laminated structure 21 before being cured or after being cured, and the pins 32 are inserted into the composite laminated structure 21 in a process of molding or jointing the composite laminated structures 21 to thereby be Z-pinned.

Here, since the Z-pinning patch 30 includes the plurality of pins 32 densely disposed on the base plate 31, the Z-pinning patch 30 may stably stand by oneself by the pins 32. Therefore, a separate guide apparatus, a separate support means, or the like, is not required. That is, since the Z-pinning patch 30 according to an exemplary embodiment of the present invention does not require a separate component (that is, the separate guide apparatus, the separate support means, or the like) other than itself, the number of components required in a Z-pinning process is minimized. In addition, as the number of separate components is deceased, processes of assembling or disposing the separate components are naturally deleted. Therefore, the number of processes is also minimized.

A more detailed description for the number of processes will be provided below. The Z-pinning patch 30 according to an exemplary embodiment of the present invention may be supplied in a state in which the manufacture thereof is completed before a composite molding process. That is, a worker in a field in which the composite molding process is performed orders a Z-pinning patch 30 having a desired specification from the outside, receives the Z-pinging patch 30 separately manufactured in the outside, and disposes and molds the Z-pinging patch 30 on a desired portion at the time of performing the molding process. That is, in an exemplary embodiment of the present invention, since the Z-pinning patch 30 is supplied in a state in which it is manufactured in advance, only a process of disposing the Z-pinning patch 30 on a desired portion is substantially added to an existing molding process in order to perform the Z-pinning, such that the Z-pinning process may be significantly simplified.

As described above, when the Z-pinning patch 30 according to an exemplary embodiment of the present invention is used, the number of components and the number of processes in the Z-pinning process may be minimized. Therefore, resources such as a time, manpower, a cost, and the like, may be significantly saved, such that a manufacturing cost may be significantly decreased and production efficiency may be significantly increased.

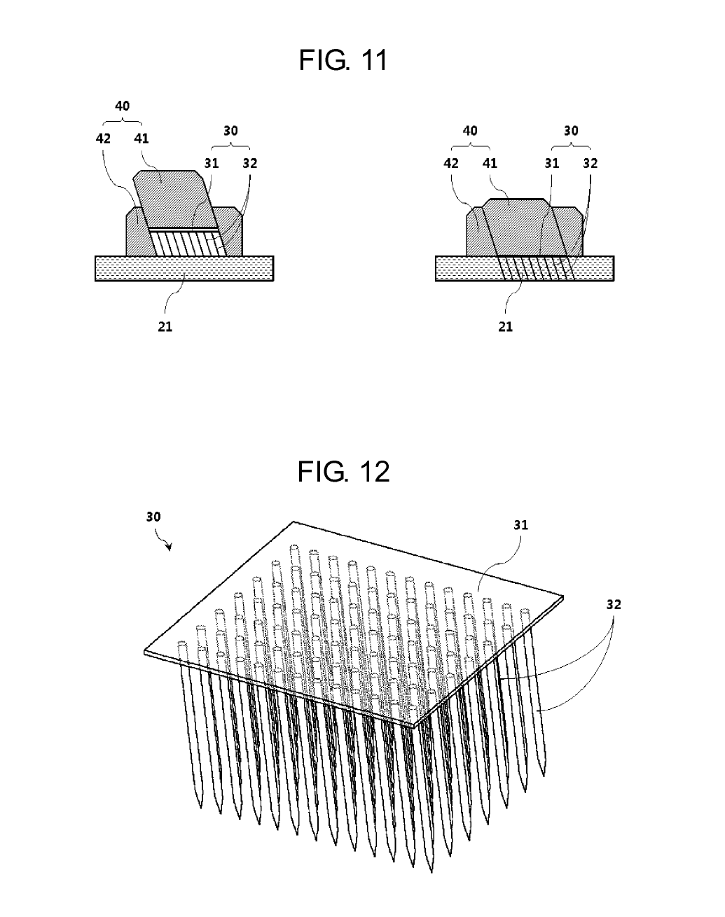

A form of the Z-pinning patch 30 will be described below in more detail. In the Z-pinning patch 30, the pin 32 may be formed in a form in which it protrudes in a direction perpendicular to the base plate 31, as shown in FIGS. 5 and 6, and this form is the most basic form. The pin 32 may also be formed in a form in which it protrudes in a direction inclined with respect to the base plate 31, as shown in FIG. 11, depending on a direction, a magnitude, or the like, of a load to be applied to the composite laminated structure 21 (that may be predicted in advance) when the composite laminated structure 21 is finally disposed and used, so as to more effectively reinforce jointing force. FIG. 12 shows an example of the Z-pinning patch 30 having a form in which the pin 32 protrudes so that it is inclined in one direction with respect to the base plate 31 as in FIG. 11.

In an example FIGS. 5, 6, 11, and 12, a form in which the plurality of pins 32 are formed so that angles at which they protrude with respect to the base plate 31 are the same as each other, that is, so that they are in parallel with each other, is shown. For example, in the case in which the pins 32 are differently formed, for example, in the case in which angles of the pins 32 intersect with each other, jointing strength after jointing may be increased, but it may be excessively difficult to actually insert the pins. A large number of thin reinforced fibers are present in a prepreg forming the composite laminated structure 21. Therefore, when directions of the pins 32 intersect with each other, even though a resin has flexibility due to a high temperature at the time of performing the molding, it is difficult to physically the pins 32 into the composite laminated structure 21, and it is likely that the reinforced fiber will be damaged even though the pins 32 are inserted into the composite laminated structure 21. Therefore, it is preferable that angles at which the pins 32 protrude with respect to the base plate 31 are the same as each other.

In addition, it is the most preferable that the pin 32 is formed so as to have the same height as a thickness of the composite laminated structures 21 after being cured or coupled. In the case in which the pin 32 has a height higher than the thickness of the composite laminated structures 21 after being cured or coupled, the other end portion of the pin 32 protrudes outwardly of the composite laminated structures 21 after being cured or coupled, which is not preferable. On the other hand, in the case in which the pin 32 has a height lower than the thickness of the composite laminated structures 21 after being cured or coupled, there is an advantage that the pin 32 does not protrude outwardly of the composite laminated structure 21, but jointing force may be slightly decreased. Therefore, it is the most preferable that the pin 32 is formed so as to have the same height as the thickness of the composite laminated structures 21 after being cured or coupled, as described above.

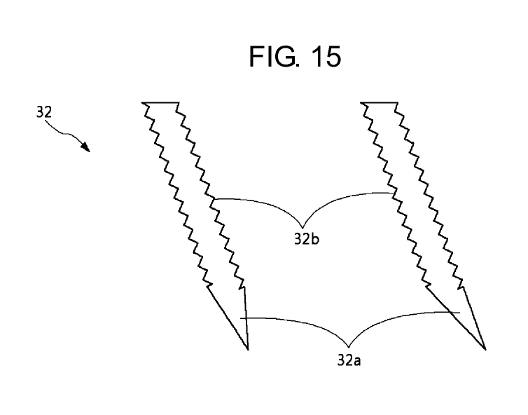

In addition, obviously, it is preferable that the other side, that is, a lower end portion 32a, of the pin 32 has a sharp form, as shown in FIG. 15, so that the pin 32 is easily inserted into the composite laminated structure 21. When performing the Z-pinning process in a molding step, the composite laminated structure 21 is softened by a high temperature, such that even though a distal end of the pin 32 is slightly bluntly formed, it is not substantially problematic to perform the Z-pinning, which will be described below in more detail. However, the Z-pinning patch 30 according to an exemplary embodiment of the present invention is not used in only the molding process, but may also be used in order to couple several members formed of the composite structure after being cured to each other, which will be described in more detail. In this case, a process of applying a heat or a pressure to the composite structure may be required in order to re-mold the composite structure. It is the most preferable that the other side of the pin 32 is sharp in order to make the insertion of the pin 32 more advantageous.

In addition, it is more preferable that the pin 32 has an unevenness 32b formed on a surface thereof, as shown in FIG. 15. The unevenness 32b is formed, thereby making it possible to further increase preventing force for separation of the pin due to an external load after the molding. Furthermore, when the surface of the pin is chemically etched, adhesion characteristics may be further improved.

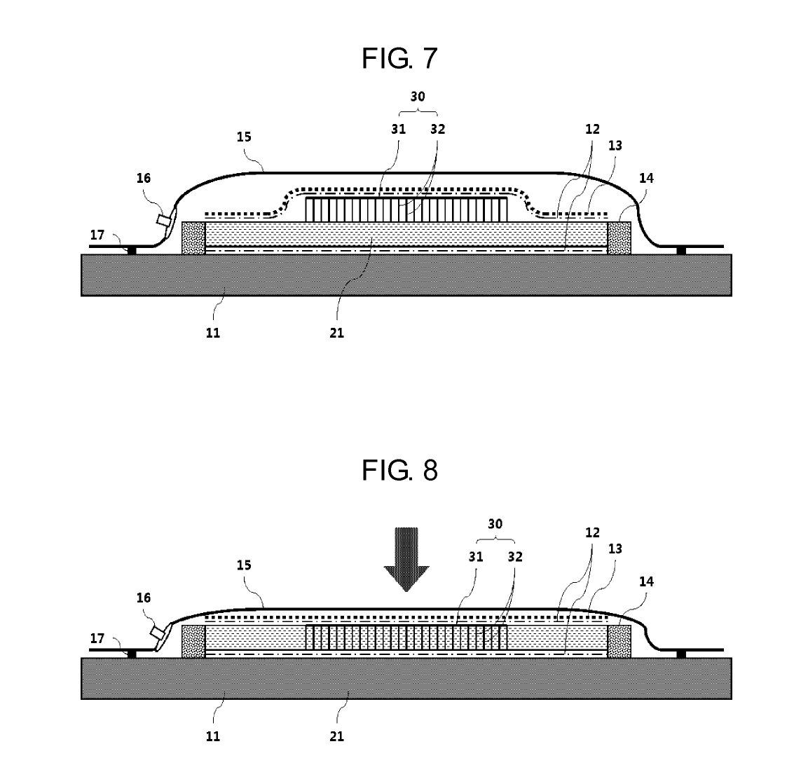

FIGS. 7 and 8 show a method for manufacturing a composite laminated structure using a Z-pinning patch according to an exemplary embodiment of the present invention. The Z-pinning patch 30 and the method for manufacturing a composite laminated structure using the same according to an exemplary embodiment of the present invention will be described with reference to FIGS. 7 and 8.

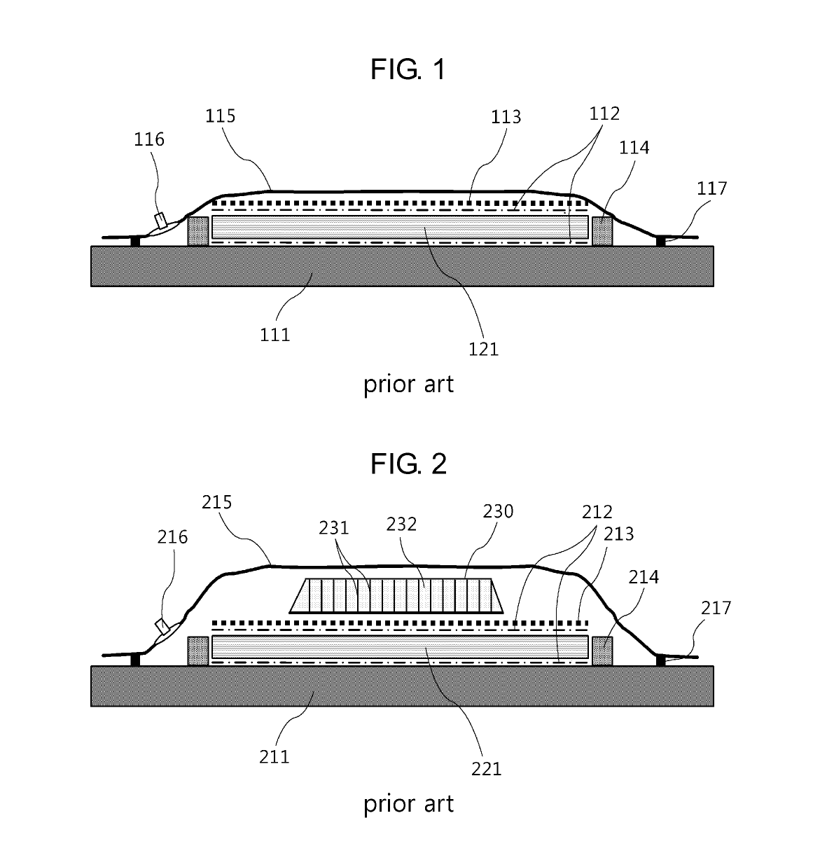

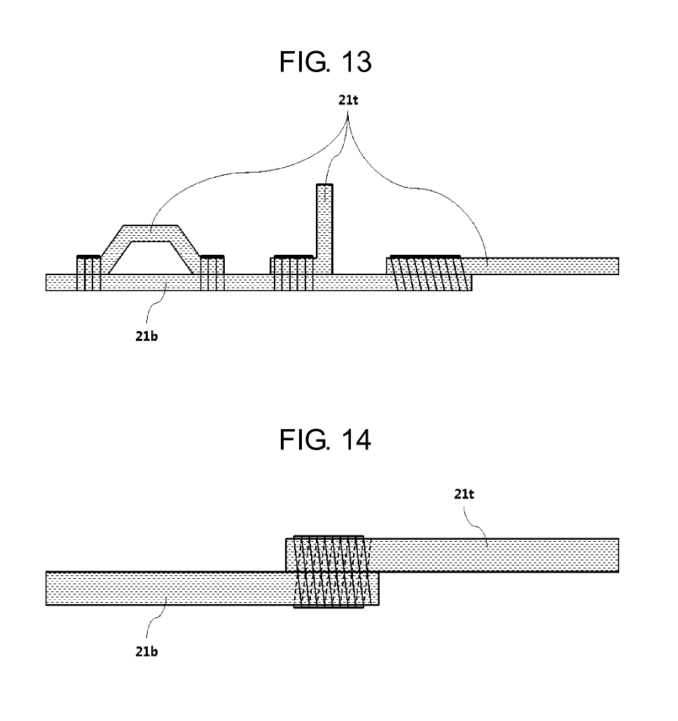

First, a method for molding a composite using the Z-pinning patch 30 according to an exemplary embodiment of the present invention is basically similar to a general method for molding a composite. That is, as in the general method for molding a composite as shown in FIG. 1, a release agent 12 is applied onto a mold 11 for molding a composite, a composite prepreg laminate 21 is disposed thereon, the release agent 12 and a bleeder 13 absorbing a resin are applied, an entire composite is covered by a film bag 15 to which an adaptor 16 providing vacuum is attached, and an edge of the composite is sealed by a sealant 17. A cork dam 14 may not also be used depending on a feature of a molding method for molding the composite laminated structure 21. In the present specification, a state before being cured indicates a state in which prepregs are laminated, and a state after being cured indicates a state in which a molding pressure is applied to the laminated prepregs, such that molding is completed. That is, the pins may be inserted into the prepregs simultaneously with molding the prepregs in a state in which the prepregs are laminated, the pins may be inserted into the laminated prepregs and a general composite molding process may be performed to complete the composite laminated structure, the pints may be inserted into the composite laminated structure that has been already cured in a re-molding process, or the pins may be inserted into a plurality of composite laminated structures before being cured or after being cured in order to couple the plurality of composite laminated structures to each other. (The final case will be described in more detail in a description for FIG. 13.)

In an exemplary embodiment of the present invention, as shown in FIG. 7, as in a first step of an existing method for molding a general composite laminated structure, the composite laminated structure 21 before being cured or after being cured is disposed. Next, the Z-pinning patch 30 is disposed on the composite laminated structure 21 before being cured or after being cured so that the other side of the pin 32 contacts the composite laminated structure 21. Describing it in more detail with reference to the drawings, the Z-pinning patch 30 is disposed between the composite laminated structure 21 and the release agent film 12 over the composite laminated structure 21.

Next, as shown in FIG. 8, pressing force is applied to the base plate 31 to press the Z-pinning patch 30, such that the pins 32 are inserted into the composite laminated structure 21. As a result, the Z-pinning using the Z-pinning patch 30 according to an exemplary embodiment of the present invention is completed. In a step of FIG. 8, actually, viscosity of a resin in the prepreg is decreased due to a high temperature applied to the prepreg in the molding process and a pressure is applied to the Z-pinning patch 30 by a high pressure, such that the pins 32 of the Z-pinning patch 30 may be easily inserted into the composite laminated structure 21.

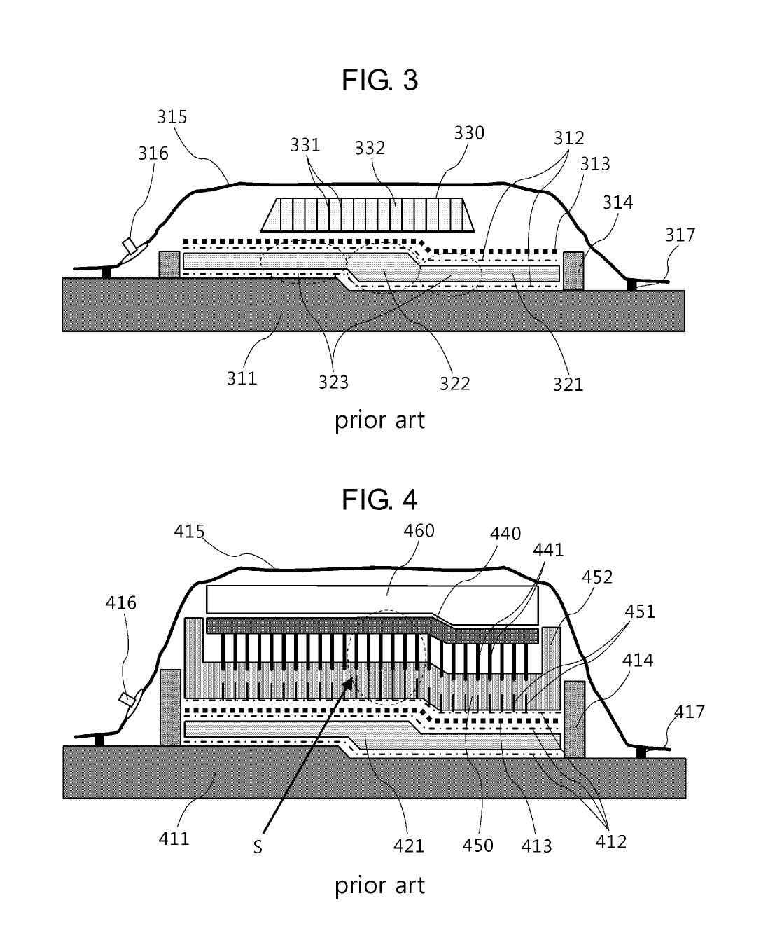

Here, in the case of the Z-pinning technology according to the prior art as shown in FIGS. 2 to 4, a separate member exposed to the outside is not viewed in the composite laminated structure finally manufactured after the Z-pinning (since the pins are completely inserted into the composite laminated structure). However, in the case of an exemplary embodiment of the present invention, the pins 32 are completely inserted into the composite laminated structure 21, while the base plate 31 is exposed to the outside of the composite laminated structure 21. This slightly increases a weight of the finally manufactured composite laminated structure and makes an appearance of the finally manufactured composite laminated structure slightly bad. However, when the base plate 31 is manufactured so as to be sufficiently thin, the increase in the weight of the composite laminated structure becomes a substantially ignorable level, and the appearance problem of the composite laminated structure, which is too insignificant to be actually considered in a field in which the composite laminated structure is used, is substantially ignorable. Furthermore, the base plate 31 remains outside the composite laminated structure 21 to protect a corresponding portion from the outside, thereby making it possible to obtain an additional effect of further reinforcing the corresponding portion.

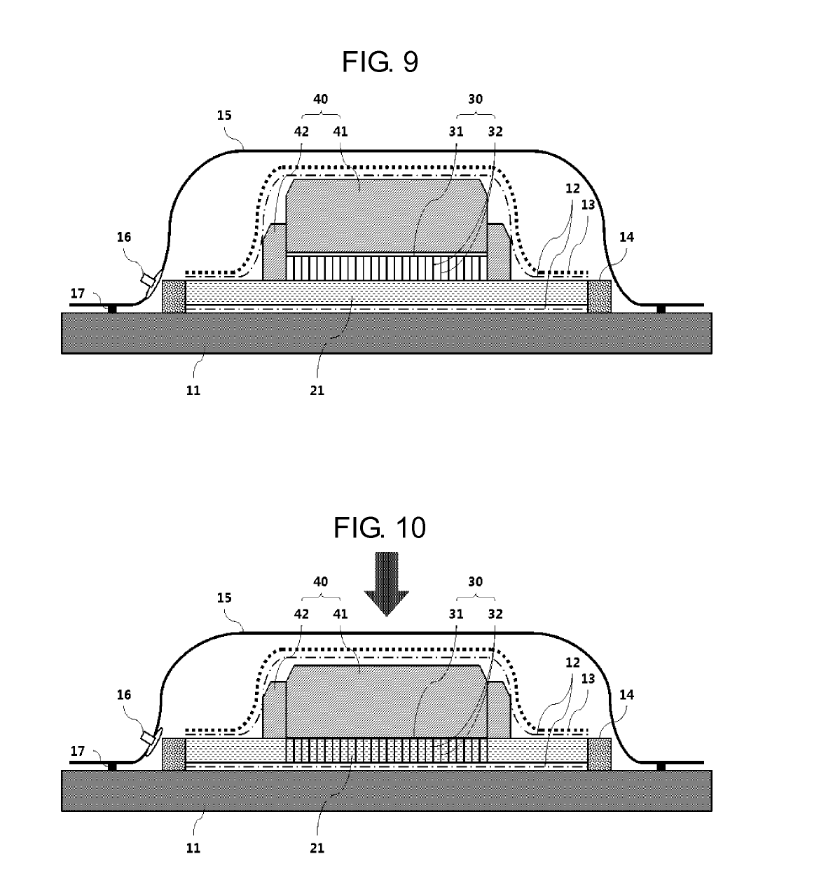

FIGS. 9 and 10 show a method for manufacturing a composite laminated structure using a Z-pinning patch according to another exemplary embodiment of the present invention. Here, a patch guide 40 inducing and guiding an insertion path of the Z-pinning patch 30 is further used. The patch guide 40 is configured to include a lower guide 42 having an opening part formed therein so that the Z-pinning patch 30 passes therethrough and an upper guide 41 disposed at one side of the opening part of the lower guide 42 so as to be inserted and moved into the opening part, as shown in FIGS. 9 and 10. The opening part formed in the lower guide 42 may have a hole form in the case in which the lower guide 42 has a form in which it completely encloses the Z-pinning patch 30. Alternatively, the opening part may have a form in which it is appropriately opened so that the Z-pinning patch 30 may pass therethrough in the case in which the lower guide 42 has a form in which it does not completely enclose the Z-pinning patch 30, but encloses only a portion of the Z-pinning patch 30. In addition, the upper guide 41 is disposed at one side of the lower guide 42 and is vertically movable (as shown in FIGS. 9 and 10). Since this jointing form between the upper guide 41 and the lower guide 42 may be easily implemented as a very simple form such as a form in which coupled parts of the upper guide 41 and the lower guide 42 are slidably coupled to each other, or the like, a detailed description thereof will be omitted. Although not separately shown in FIGS. 9 and 10, a release agent may be applied to surfaces of the upper and lower guides 41 and 42 in order to facilitate separation between the upper and lower guides 41 and 42 and the composite laminated structure after being cured.

A manufacturing method in the case of using the patch guide 40 as described above will be described. First, in the existing method for molding a general composite laminated structure or the method for manufacturing a composite laminated structure according to an exemplary embodiment of the present invention shown in FIGS. 7 and 8 (that is, a method for manufacturing a composite laminated structure without the patch guide 40), the composite laminated structure 21 before being cured or after being cured is disposed, and the Z-pinning patch 30 is disposed on the composite laminated structure 21 before being cured or after being cured so that the other side of the pin 32 contacts the composite laminated structure 21.

Next, as shown in FIG. 9, the Z-pinning patch is covered with the patch guide 40 so that it is inserted into the opening part of the lower guide 42. Finally, pressing force is applied to the upper guide 41 to press the Z-pinning patch 30, such that the pins 32 are inserted into the composite laminated structure 21. As a result, the Z-pinning using the Z-pinning patch 30 and the patch guide 40 according to an exemplary embodiment of the present invention is completed. The patch guide 40 may be lifted and removed after the Z-pinning is completed and may be re-used without limit.

The reason why the patch guide 40 is used as described above is as follows. In the method for manufacturing a composite laminated structure using the Z-pinning patch according to an exemplary embodiment of the present invention, the Z-pinning patch 30 may be stably maintained in a form in which it stands by oneself due to its form in which a plurality of pins 32 are disposed, as described above. However, in the case in which an area of a part at which jointing force is to be increased (hereinafter, referred to as a coupled part) is significantly narrow, (since it is natural that an area of the base plate 31 is the same as that of the coupled part), the area of the base plate 31 is narrowed, such that the number of pins 32 is significantly decreased. When the area of the coupled part is very narrow, the number of pins 32 is excessively decreased, such that even though the Z-pinning patch 30 may stand by oneself, it is likely that the Z-pinning patch 30 will collapse when pressing forces is applied to the Z-pinning patch 30. The patch guide 40 is used in order to exclude this likelihood.

That is, the patch guide 40, which is used to prevent a phenomenon that the Z-pinning patch 30 collapses at the time of performing the jointing since an area of the Z-pinning patch 30 itself becomes very small due to the very narrow coupled part, may not be used as shown in FIGS. 7 and 8 in the case in which the coupled part is sufficiently wide. Alternatively, even though the coupled part is sufficiently wide, in the case in which the Z-pinning patch 30 is formed so that all of the pins 32 are inclined in one direction as shown in FIG. 11, when the pressing force is applied to the Z-pinning patch 30, it is likely that the Z-pinning patch 30 will collapse. In this case, it is preferable that the patch guide 40 that is appropriately designed is used. In the case in which the Z-pinning patch 30 is formed so that all of the pins 32 are inclined in one direction as shown in FIG. 11, the patch guide 40 is designed so that a direction in which the upper guide 41 is inserted and moved into the lower guide 42 is the same as the direction in which the pins 32 are inclined. Although several forms of the patch guides 40 as described above are variously shown in FIGS. 9 and 11, the present invention is not limited thereto. That is, a form of the patch guide 40 may be variously changed depending on several factors that may be considered by a designer such as an area or a form of the coupled part, a direction in which the pins 32 are inclined, an intention of the designer, or the like.

FIG. 13 shows composite laminated structures coupled to each other by a method for jointing a composite laminated structure using a Z-pinning patch. Basically, the method for jointing composite laminated structures to each other using a Z-pinning patch according to an exemplary embodiment of the present invention is the same in a process of pressing and inserting the Z-pinning patch 30 into the coupled part to complete the Z-pinning as the method for manufacturing a composite laminated structure described above, except that several composite laminated structures are initially laminated.

That is, more specifically, in order to couple several members to each other as shown in FIG. 13, a lower composite laminated structure member 21b and an upper composite laminated structure member 21t are sequentially disposed from the bottom, the Z-pinning patch 30 is disposed on the upper composite laminated structure member 21t so that the other side of the pin 32 contacts the upper composite laminated structure member 21t, and the pressing force is applied to the base plate 31 to insert the pins 32 into the laminated composite laminated structure members 21b and 21t, such that a process of jointing composite laminated structures to each other using the Z-pinning patch according to an exemplary embodiment of the present invention is completed.

In the case in which the patch guide 40 is used, the lower composite laminated structure member 21b and the upper composite laminated structure member 21t are sequentially disposed from the bottom and the Z-pinning patch 30 is disposed on the upper composite laminated structure member 21t so that the other side of the pin 32 contacts the upper composite laminated structure member 21t, which is the same as the process as described in the previous paragraph. Then, the Z-pinning patch 30 is covered with the patch guide 40 so that it is inserted into the opening part of the lower guide 42. Finally, the pressing force is applied to the upper guide 41 to insert the pins 32 into the laminated composite laminated structure members 21b and 21t, such that the process of jointing composite laminated structures to each other using the Z-pinning patch 30 (and the patch guide 40) according to an exemplary embodiment of the present invention is completed.

Here, in the case in which the composite laminated structure members 21b and 21t (that is, the upper composite laminated structure member 21t and the lower composite laminated structure member 21b that are laminated) are in a state in which they coupled to each other in advance through a primary jointing process including an adhering process, a compressing process, or a heat-attaching process, an jointing effect may be further improved. When the composite laminated structure members 21b and 21t are in a state in which they are primarily coupled to each other as described above, a risk that the composite laminated structure members 21b and 21t will deviate from accurate positions at the time of being coupled to each other using the Z-pinning patch 30 is significantly decreased, thereby making it possible to increase process efficiency and minimize a defective rate.

FIG. 14 shows that the Z-pinning patches 30 are applied to upper and lower portions in order to increase a jointing effect between two members. In an example of FIG. 14, two Z-pinning patches 30 including the inclined pins 32 are applied to the upper and lower portions, respectively, such that the pins 32 of each of the upper Z-pinning patch 30 and the lower Z-pinning patch 30 intersect with each other. As described above, directions of the upper and lower pins 32 are different from each other, such that the jointing effect between the two members may be further increased. A method for manufacturing composite laminated structures shown in FIG. 14 is substantially similar to the methods for manufacturing a composite laminated structure as described above. That is, the lower Z-pinning patch 30 may be inserted at an appropriate depth into the laminated prepregs before being cured by a method for applying an appropriate load (for example, a high frequency vibration load) to the laminated prepregs, or the like, and the upper Z-pinning patch may be manufactured by the molding method described above.

According to the prior art, a metal rivet, a bolt, or the like, should be used in order to couple the composite laminated structure members to each other. Therefore, separate components such as the rivet, the bolt, or the like, were required, and an assembling processing the separate components was required. However, according to an exemplary embodiment of the present invention, these separate components are not required, such that a separate assembling process is not required. As a result, resources such as a time, a cost, manpower, and the like, may be significantly saved in a jointing process, and productivity may be improved in a jointing process, and productivity may be improved. In addition, since the Z-pinning patch 30 according to an exemplary embodiment of the present invention is much lighter than the rivet, the bolt, or the like, which are jointing components that have been used in the prior art, it is much more advantageous in view of lightness than the rivet, the bolt, or the like.

The present invention is not limited to the above-mentioned exemplary embodiments but may be variously applied, and may be variously modified by those skilled in the art to which the present invention pertains without departing from the gist of the present invention claimed in the claims.

### INDUSTRIAL APPLICABILITY

According to an exemplary embodiment of the present invention, a problem that a material is inevitably wastefully spent due to the use of a one-time ‘form structure’ (including a ‘reinforced structure’) in the Z-pinning method according to the prior art and it is difficult to apply the Z-pinning method according to the prior art to a composite laminated structure having a non-uniform thickness may be completely solved. That is, in an exemplary embodiment of the present invention, the Z-pinning is performed using a patch having a form in which a plurality of pins are vertically formed on a thin plate, and this patch is manufactured in advance and is then supplied, such that a process of actually manufacturing a composite laminated structure itself is may be significantly simplified. In more detail, components such as a form structure, a reinforced structure, various jigs, and the like, according to the prior art are not required, such that the number of components and the number of processes may be significantly decreased. Therefore, a manufacturing cost is decreased and production efficiency is improved, as compared with the prior art, such that an excellent economical effect may be accomplished.

1. A Z-pinning patch used for Z-pinning for reinforcing delamination performance of composite laminated structures or connecting between a plurality of laminated members, comprising:
a base plate formed in a plate form; and
a plurality of pins fixed to one side of the base plate and formed in a form in which they protrude in a vertical direction or in an inclined direction.

2. The Z-pinning patch of claim 1, wherein the pin side is disposed on the composite laminated structure before being cured or after being cured, and the pins are inserted into the composite laminated structure in a process of molding or jointing the composite laminated structures to thereby be Z-pinned.

3. The Z-pinning patch of claim 1, wherein it is guided by a patch guide including a lower guide having an opening part formed therein so that the Z-pinning patch passes therethrough and an upper guide disposed at one side of the opening part of the lower guide so as to be inserted and moved into the opening part, such that it is inserted into the composite laminated structure.

4. The Z-pinning patch of claim 1, wherein the pin has a lower end portion formed in a sharp form.

5. The Z-pinning patch of claim 4, wherein the pin has an unevenness formed on a surface thereof.

6. The Z-pinning patch of claim 4, wherein the pin has a chemically etched surface.

7. A method for manufacturing a composite laminated structure using the Z-pinning patch of claim 1, comprising:
a1) disposing the composite laminated structure before being cured or after being cured;
a2) disposing the Z-pinning patch on the composite laminated structure before being cured or after being cured so that the other side of the pin contacts the composite laminated structure; and
a3) applying pressing force to the base plate to insert the pins into the composite laminated structure.

8. A method for manufacturing a composite laminated structure using the Z-pinning patch of claim 3, comprising:
b1) disposing the composite laminated structure before being cured or after being cured;
b2) disposing the Z-pinning patch on the composite laminated structure before being cured or after being cured so that the other side of the pin contacts the composite laminated structure;
b3) covering the Z-pinning patch with the patch guide so that the Z-pinning patch is inserted into the opening part of the lower guide; and
b4) applying pressing force to the upper guide to insert the pins into the composite laminated structure.

9. A method for manufacturing a composite laminated structure using the Z-pinning patch of claim 2, comprising:
a1) disposing the composite laminated structure before being cured or after being cured;
a2) disposing the Z-pinning patch on the composite laminated structure before being cured or after being cured so that the other side of the pin contacts the composite laminated structure; and
a3) applying pressing force to the base plate to insert the pins into the composite laminated structure.
